(19) United States
(12) Patent Application Publication
(10) Pub. No.: US 2025/0008192 A1
(43) Pub. Date: Jan. 2, 2025

(54) SYSTEM AND METHOD FOR AUGMENTING A LIVE BROADCAST OF A SPORTING EVENT AT DIFFERENT LEVELS

(71) Applicant: International Business Machines Corporation, Armonk, NY (US)

(72) Inventors: Girmaw Abebe Tadesse, Nairobi (KE); Aisha Walcott, Nairobi (KE); Michael S. Gordon, Croton on Hudson, NY (US); James R. Kozloski, New Fairfield, CT (US); Komminist Weldemariam, Ottawa (CA)

(21) Appl. No.: 18/216,641

(22) Filed: Jun. 30, 2023

(51) Int. Cl. H04N 21/488; H04N 21/2187; H04N 21/258

(52) U.S. Cl. CPC H04N 21/488; H04N 21/2187; H04N 21/25883

(57) ABSTRACT

Augmenting a live broadcast of a sporting event includes receiving or generating a data stream of a live broadcast of a sporting event, generating commentary on the live broadcast in real time at a plurality of different levels of knowledge of the sport of the sporting event being broadcast, determining a knowledge level of the sport of a user, and providing the generated commentary at one of the plurality levels of knowledge of the sport to a user in real time based on the determined knowledge level of the sport of the user.

### BACKGROUND

This disclosure is directed to computers, and computer applications, and more particularly to computer-implemented methods and systems for augmenting a live broadcast of a sporting event.

When watching sporting events, the commentators give play-by-play observations to the audience as if they (the audience) were experts and have watched and/or participated in these sporting events before. An example is watching curling in the winter Olympics—as matches and practices at other times of the year are often not televised. The commentators give play-by-play results and discuss the nuances of the game while keeping up with the score, but this is confusing for the viewers who don't understand the rules and perhaps haven't watched matches since the last Olympics.

Viewers typically disengage from viewing a sport event if some of the rules and context are unclear to them, which may result in service providers being disadvantaged by losing or failing to grow subscriptions. In addition, sport event organizers are not able to get the general public feedback.

### SUMMARY

One embodiment of a computer implemented method for augmenting a live broadcast of a sporting event includes the steps of receiving or generating a data stream of a live broadcast of a sporting event, generating commentary on the live broadcast in real time at a plurality of different levels of knowledge of the sport of the sporting event being broadcast, determining a knowledge level of the sport of a user, and providing the generated commentary at one of the plurality levels of knowledge of the sport to a user in real time based on the determined knowledge level of the sport of the user.

A system that includes one or more processors operable to perform one or more methods described herein also may be provided. A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram of one embodiment of the method disclosed in this specification.

FIG. 2 is a block diagram of one embodiment for the system disclosed herein.

FIG. 3 is a block diagram of one embodiment of a system for smoothly transitioning of the level of commentary based on user's understanding inferred using a user assistant.

FIG. 4 is a block diagram of an exemplary computing system suitable for implementation of the embodiments of the invention disclosed in this specification.

### DETAILED DESCRIPTION

In some embodiments, there is disclosed a system and method for providing the experience of viewing sporting events to audiences at different levels of knowledge of the sport. In some embodiments, the system and method disclosed herein provides the generation of commentary based on the knowledge level of viewers. The system and method disclosed herein improves sport content creation and improves the viewer experience of the sporting events over prior art systems. In some embodiments, the system and method disclosed herein provides a service of augmented personalized commentary of a live broadcast service based on a preference of a user. In some embodiments, the interest or the level of knowledge of the user is inferred from provided prompts or prior experience with the system. In some embodiments, commentators with a wide range of expertise are mapped to potential users and levels of understanding. In some embodiments, the system generates commentary dynamically based on the level of interaction with the user. In some embodiments, the system may use large AI language models (e.g., WatBERT, ChatGPT-based models) for generating the commentary.

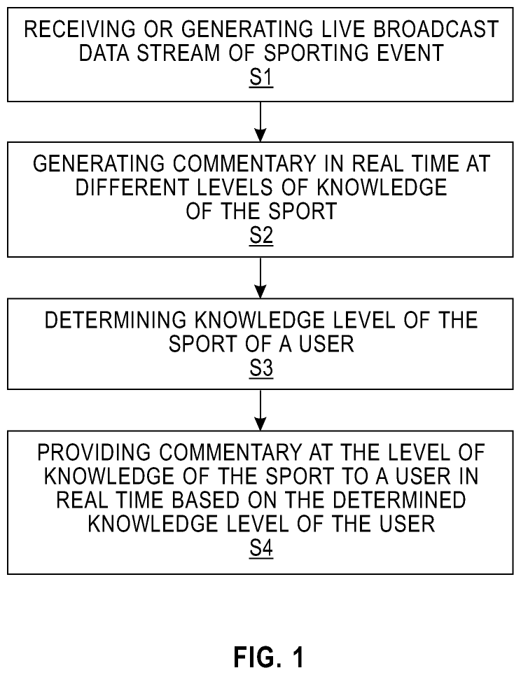

FIG. 1 is a flow diagram of one method for augmenting a live broadcast of a sporting event comprising step S1 of receiving or generating a data stream of a live broadcast of a sporting event, step S2 of generating commentary on the live broadcast in real time at a plurality of different levels of knowledge of the sport of the sporting event being broadcast, step S3 of determining a knowledge level of the sport of a user, and step S4 of providing the generated commentary at one of the plurality levels of knowledge of the sport to a user in real time based on the determined knowledge level of the sport of the user. In some embodiments, in step S1 experts in the sport would watch the live feed and in step S2 record their commentary, in real time, for different skill levels. In some embodiments, in step S4, the generated commentary is embedded in the data stream of a live broadcast of a sporting event. In some embodiments, the generated commentary is synchronized with the broadcast of the live sporting event.

In some embodiments, in step S3, determining the knowledge of the user includes providing multiple options for the viewer, such as expert understanding, intermediate and novice understanding, for the viewer to choose an option that better suits their understanding level.

Some embodiments further include automatically transitioning the generated commentary provided to the user from one level of knowledge of the sport to another level of knowledge of the sport. This transition can be done at the background where the user may be requested to add additional user-specific promote (e.g., preferences, interactivity, etc.) wherein the AI workflow can adjust the commentary accordingly.

In some embodiments, the system and method disclosed herein automatically transitions users in the same cluster from one level of knowledge to another. In some embodiments, the system and method disclosed herein provides the ability to transition viewers from one level of commentary to another higher level of commentary using an in-build knowledge testing guided by trained AI model. In some embodiments, the terminologies in the sport of interest are used to build knowledge graphs that are used, for example, to generate lower-expertise level commentary for higher-expertise level commentary and vise-versa. The built knowledge graphs can be incorporated into a large language model.

In some embodiments, the system and method disclosed herein provides a social media service, where users share commentaries of interest in real time as simulcasts with ongoing programming through traditional media and social medias. The system and method disclosed, in these embodiments, leverages social media networks to perform one or more of steps S1-S4. In one embodiment, the commentary on the live broadcast is provided as a service on one or more social media platforms to enable collaborative explanation of sporting events at different levels by subscribers of the social media service. In some embodiments, the system and method disclosed herein provides a mechanism to enable collaboration between similar-level viewers for a better experience. In these embodiments of the system and method disclosed, the integration of social networks and users in generating and streaming different levels of commentaries is provided. The interaction among clustered users based on their viewing preference is utilized to improve the viewing experiences. The disclosed system can be interfaced with generative model services such as ChatGPT to learn generation interaction patterns among different classes of users.

In some embodiments, the one of more social media platforms may invoke different experts to generate the commentary which can be synchronized across the platforms in different modes (text, audio, graphics, etc.). In some embodiments, users of the service may generate their own commentary and annotate their commentary with identification information such as name, description of sport, etc., and category information, such as, humorous, beginners, serious, fantasy, etc.

In some embodiments, the service is configured to allow any user to create an account and tag a real time broadcast with a searchable code corresponding to the media broadcast over which they will be adding their commentary as a simulcast. Examples of searchable codes may include a television or radio station and time of day, a photograph of the screen of the station, and/or a hash provided by the service itself after locating the program in a database. In some embodiments, viewers who wish to receive the commentary would pay a fee to use the service, would complete a survey with their preferences for watching/listening to commentary at different skill levels. For instance, curling: beginner, American football: intermediate, tennis: expert-so that when they watch the events the desired level of commentary is matched with the presented broadcast. In some embodiments, the service with the generated alternative explanation is broadcast at the same time as the main broadcast so that it remains synchronized to the player's actions when viewed. The main broadcast could be a live broadcast or a replay broadcast.

Viewers that wish to use the service will search for broadcasts using the searchable code, and for categories of simulcast commentary by the service broadcasters. Upon playing the simulcast commentary, a viewer of the service may discover additional services available to mix, unify and synchronize the original broadcast program with the service's many simulcast commentaries.

In some embodiments, the social media system may identify a cohort of viewers or a network of viewers to join one or more instance of virtual/online services that broadcasts an ongoing sporting event. In some embodiments, the social media system may also match one or more expert commentaries to join or rejoin the virtual/online services to explain a particular event/scene according to the level of interest to the cohort or group of viewers.

The system and method disclosed, in some embodiments, leverages a shared virtual or real environment, such as the metaverse, to perform one or more of steps S1-S4. In some embodiments, the request to join or rejoin the virtual/online services run on the new social media system is based on tracking a viewer's gaze or group of viewers' gazes in the shared or real environment to estimate the location of a visual point of interest (POI), tracking of the movement of the POI on the sports activity field where there is a need to explain a specific sporting event at different levels for the cohort or viewers in a group setting, which may be joined to virtual/online services. The system may also dynamically update the content with an explanation on an electronic display based on desired level of commentary for the cohort or viewers.

In one embodiment, the generated commentary on the live broadcast at the plurality levels of knowledge of the sport are provided to a plurality of users in real time based on a determined knowledge level of the users in the shared virtual or real environment. In these embodiments, the viewer experience is augmented by dynamically creating a similar viewer community watching the event in the shared virtual or real environment. Viewers may use virtual reality (VR) or augmented reality (AR) goggles while watching the sporting event and if the broadcaster level needs to be adapted the viewer will seamlessly view the sporting event in a virtual or real environment with peers who have the same level of understanding. In this virtual or real environment, examples of specific techniques discussed by the broadcaster can be illustrated in real-time to support viewer understanding. In some embodiments, the new social media system can be created in the metaverse environment wherein the metaverse and real-world viewing experiences can be synchronized using a knowledge graph.

In some embodiments, step S2 includes generating real-time translation of the generated commentary at a plurality of different levels of knowledge in a plurality of languages and step S4 includes providing the translated commentary on the live broadcast at one of the plurality levels of knowledge of the sport to a user in real time based on the determined knowledge level of the user. In some embodiments, multi-tasking foundational models are used to translate the generated commentaries. In some embodiments, step S2 includes embedding real-time translation across different languages of the generated commentary in the social media network service to enable collaborative explanation of sporting events at different levels and in different languages by subscribers of the social media service.

In some embodiments, step S4 includes automatically transitioning the generated commentary provided to the user from one level of knowledge of the sport to another level of knowledge of the sport. In some embodiments, the automatically transitioning of the generated commentary is based on an in-build knowledge testing of the sporting event. In some embodiments, the in-build testing may include a number of explanations attended passed a specified threshold, and/or a number of comments from viewers that are matched with known explanations stored in a database.

In some embodiments, step S3 includes predicting the user's level of knowledge or understanding of the sport being broadcast based on other sporting events they have watched. In some embodiments, the system and or service can dynamically adapt the broadcasting based on the predicted user level smoothly. If available, a user's voice activated assistant device can interact with the users to gauge their level of knowledge or understanding and act as an intermediary to the sporting content. By listening to specific phrases and inferring whether the user understands the sport based on what they say, detecting confusion, etc. In one embodiment, the user's voice activated assistant like can trigger/promote a commentator to the user if the detected confusion level is above specified threshold level.

In some embodiments, step S3 includes determining the user's experience in sports similar to the sport being broadcast sports. One example of such is the similarity between football and rugby. In some embodiments, the user's experience in these other sports is utilized in step S2 to determine which levels of knowledge to generate the commentary. In some embodiments, the user's experience in these other sports is utilized in step S4 to determine which level of commentary to provide.

In some embodiments, the system and method may include in step S2 providing the user the ability to select a preferred expert to generate the commentary. In some embodiments, step S2 may be performed by a system for generating automated commentary, such as by using AI.

In some embodiments, in step S2, the focus of the commentary is pre-specified by the user's interest. For example, a user might prefer to receive a commentary from the perspective of a single element of the sport, such as a goalkeeper. In another example, the commentary could also be conditioned to focus on certain aspects of the game, such as offense or defense parts of the sport.

In some embodiments, the system and method may include in step S2 providing a detailed explanation for reasons behind an action by a referee, to improve the user experience, for instance describing and showing a video clip of the actions leading to a “off-sides” call in a soccer match.

In some embodiments, the system and method may include in step S2 providing new developments in the sport, for instance in recent changes in the rules.

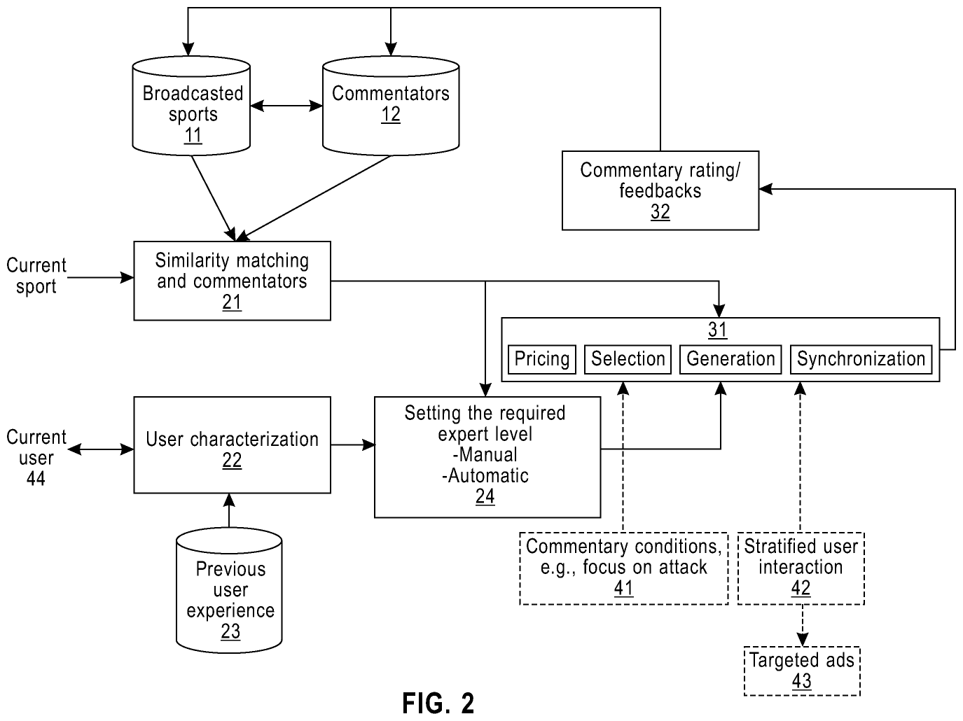

FIG. 2 is a block diagram of one embodiment for the system disclosed herein. The Broadcasted sports 11 represents a live or recorded feed of the event for commentary. Commentators 12 are real or synthetic. Both provide input to the validation component 21 that matches broadcasts to commentaries. User characterization 22 evaluates the user's level of knowledge of the sport, considering previous user experience 23, among other inputs described in the specification. The requested, desired, or determined setting of the required expert level of commentary 24 is then determined (either manually or automatically). This then leads to the functional core 31 which generates or selects the appropriate commentary from 12, and synchronizes these to the Broadcast 11. Ratings of the commentary by the user 32 are then provided back to both Broadcasters 11 and Commentators 12, to allow for a market for commentators. In some embodiments, various additional inputs to the functional core 31 include user requests for how commentators should focus their commentaries 41 according to a user's level and stratified user interaction 42. In some embodiments, targeted advertising 43 is also directed to users and inserted into commentary based on user stratification 42.

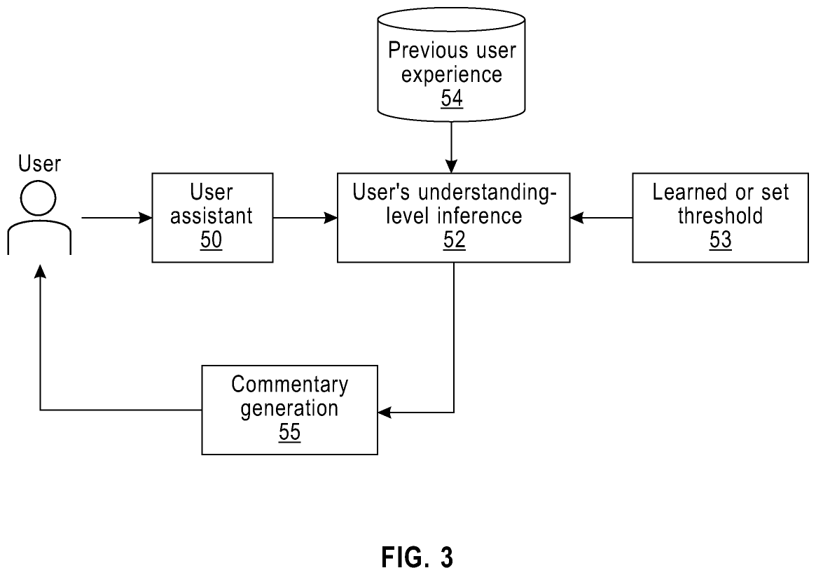

FIG. 3 is a block diagram of one embodiment of a system for smoothly transitioning of the level of commentary based on user's understanding inferred using a user assistant. A User assistant 50 provided either by the user via a private experience assessment application, or by an aggregator of user information in the system, provides inputs to a system component 52 that infers the user's expected level of understanding of the sport. Based on a learned or set threshold 53, and on the previous user experience on the system 54, commentary is generated matching the users level of understanding 55 and fed back to the user 44.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

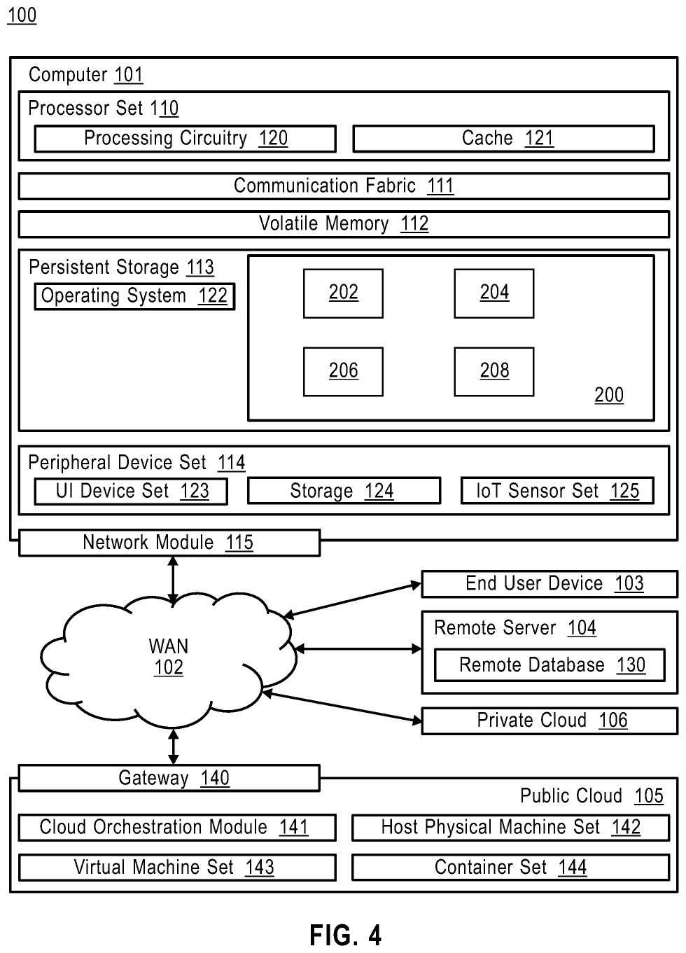

FIG. 4 is block diagram of a computing environment 100 that contains an example of an environment for the execution of at least some of the computer code involved in performing the inventive methods disclosed above, such as computer code block 200 for augmenting a live broadcast of a sporting event. Block 200 includes module 202 configured for receiving or generating a data stream of a live broadcast of a sporting event, module 204 configured for generating commentary on the live broadcast in real time at a plurality of different levels of knowledge of the sport of the sporting event being broadcast, module 206 configured for determining a knowledge level of the sport of a user and module 208 configured for providing the generated commentary at one of the plurality levels of knowledge of the sport to a user in real time based on the determined knowledge level of the sport of the user. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”).

These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area

communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices.

Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In addition, while preferred embodiments of the present invention have been described using specific terms, such description is for illustrative purposes only, and it is to be understood that changes and variations may be made without departing from the spirit or scope of the following claims.

What is claimed is:

1. A computer implemented method for augmenting a live broadcast of a sporting event comprising:
receiving or generating a data stream of a live broadcast of a sporting event;
generating commentary on the live broadcast in real time at a plurality of different levels of knowledge of the sport of the sporting event being broadcast;
determining a knowledge level of the sport of a user; and
providing the generated commentary at one of the plurality levels of knowledge of the sport to a user in real time based on the determined knowledge level of the sport of the user.

2. The method of claim 1, wherein the commentary on the live broadcast is provided on a social media service to enable collaborative explanation of sporting events at different levels by subscribers of the social media service.

3. The method of claim 1, further including generating real-time translation of the generated commentary at a plurality of different levels of knowledge in a plurality of languages and providing the translated commentary on the live broadcast at one of the plurality levels of knowledge of the sport to a user in real time based on the determined knowledge level of the user.

4. The method of claim 1, wherein the generating real-time translation of the generated commentary is based on a custom pretrained generative AI service.

5. The method of claim 4, further including automatically transitioning the generated commentary provided to the user from one level of knowledge of the sport to another level of knowledge of the sport, and wherein the automatically transitioning is based on an in-built knowledge testing of the user about the sporting event, wherein the in-built testing comprises at least one of a number of explanations attended past a specified threshold, and a number of comments from viewers that are matched with known explanations stored in a database.

6. The method of claim 1, wherein determining a knowledge level of the sport being broadcast of a user comprises predicting the user's level of knowledge based on other sporting events they have watched.

7. The method of claim 1, further including providing the generated commentary on the live broadcast at the plurality levels of knowledge of the sport to a plurality of users in real time based on a determined knowledge level of the users in a shared real or virtual environment.

8. A computer system for augmenting a live broadcast of a sporting event, comprising:
one or more computer processors;
one or more non-transitory computer-readable storage media;
program instructions, stored on the one or more non-transitory computer-readable storage media, which when implemented by the one or more processors, cause the computer system to perform the steps of:
receiving or generating a data stream of a live broadcast of a sporting event;
generating commentary on the live broadcast in real time at a plurality of different levels of knowledge of the sport of the sporting event being broadcast;
determining a knowledge level of the sport of a user; and
providing the generated commentary at one of the plurality levels of knowledge of the sport to a user in real time based on the determined knowledge level of the sport of the user.

9. The system of claim 8, wherein the commentary on the live broadcast is provided on a social media service to enable collaborative explanation of sporting events at different levels by subscribers of the social media service.

10. The system of claim 8, further including generating real-time translation of the generated commentary at a plurality of different levels of knowledge in a plurality of languages and providing the translated commentary on the live broadcast at one of the plurality levels of knowledge of the sport to a user in real time based on the determined knowledge level of the user.

11. The system of claim 8, further including automatically transitioning the generated commentary provided to the user from one level of knowledge of the sport to another level of knowledge of the sport.

12. The system of claim 11, wherein the automatically transitioning is based on an in-built knowledge testing of the user about the sporting event, wherein the in-built testing comprises at least one of a number of explanations attended past a specified threshold, and a number of comments from viewers that are matched with known explanations stored in a database.

13. The system of claim 8, wherein determining a knowledge level of the sport being broadcast of a user comprises predicting the user's level of knowledge based on other sporting events they have watched.

14. The system of claim 8, further including providing the generated commentary on the live broadcast at the plurality levels of knowledge of the sport to a plurality of users in real time based on a determined knowledge level of the users in a shared real or virtual environment.

15. A computer program product comprising:
program instructions on a computer-readable storage medium, where execution of the program instructions using a computer causes the computer to perform a method for augmenting a live broadcast of a sporting event, comprising:
receiving or generating a data stream of a live broadcast of a sporting event;
generating commentary on the live broadcast in real time at a plurality of different levels of knowledge of the sport of the sporting event being broadcast;
determining a knowledge level of the sport of a user; and
providing the generated commentary at one of the plurality levels of knowledge of the sport to a user in real time based on the determined knowledge level of the sport of the user.

16. The computer program product of claim 15, wherein the commentary on the live broadcast is provided on a social media service to enable collaborative explanation of sporting events at different levels by subscribers of the social media service.

17. The computer program product of claim 15, further including generating real-time translation of the generated commentary at a plurality of different levels of knowledge in a plurality of languages and providing the translated commentary on the live broadcast at one of the plurality levels of knowledge of the sport to a user in real time based on the determined knowledge level of the user.

18. The computer program product of claim 15, further including automatically transitioning the generated commentary provided to the user from one level of knowledge of the sport to another level of knowledge of the sport, wherein the automatically transitioning is based on an in-built knowledge testing of the user about the sporting event, wherein the in-built testing comprises at least one of a number of explanations attended past a specified threshold, and a number of comments from viewers that are matched with known explanations stored in a database.

19. The computer program product of claim 15, wherein determining a knowledge level of the sport being broadcast of a user comprises predicting the user's level of knowledge based on other sporting events they have watched.

20. The computer program product of claim 15, further including providing the generated commentary on the live broadcast at the plurality levels of knowledge of the sport to a plurality of users in real time based on a determined knowledge level of the users in a shared real or virtual environment.
